(19) United States
(12) Patent Application Publication
(10) Pub. No.: US 2015/0131482 A1
(43) Pub. Date: May 14, 2015

(54) METHOD FOR TRANSMITTING DISCOVERY SIGNAL IN DEVICE-TO-DEVICE COMMUNICATION

(71) Applicants: Electronics and Telecommunications Research Institute, Daejeon (KR); Dongguk University Industry-Academic Cooperation Foundation, Seoul (KR)

(72) Inventors: Taegyun NOH, Daejeon (KR); Minjoong RIM, Seoul (KR); Chung Gu KANG, Seoul (KR); Jae Young AHN, Daejeon (KR); Choongil YEH, Daejeon (KR); Kyoung Seok LEE, Daejeon (KR)

(21) Appl. No.: 14/538,241

(22) Filed: Nov. 11, 2014

(30) Foreign Application Priority Data
Nov. 11, 2013 (KR) 10-2013-0136504
Oct. 29, 2014 (KR) 10-2014-0148667

(51) Int. Cl. H04W 48/08; H04W 4/06; H04W 8/00

(52) U.S. Cl. CPC H04W 48/08; H04W 8/005; H04W 4/06
USPC 370/254

(57) ABSTRACT

Disclosed is a method for transmitting a discovery signal in device-to-device communication. In phase 1, for devices at a long range, a discovery signal is transmitted by dividing a band like in OFDMA, and in phase 2, for devices at a short range, the discovery signal is transmitted by using a full band.

### CROSS-REFERENCE TO RELATED APPLICATION

This application claims priority to and the benefit of Korean Patent Application No. 10-2013-0136504, and 10-2014-0148667 filed in the Korean Intellectual Property Office on Nov. 11, 2013, and Oct. 29, 2014, respectively, the entire contents of which are incorporated herein by reference.

### BACKGROUND OF THE INVENTION

(a) Field of the Invention

The present invention relates to a method for transmitting a discovery signal in device-to-device communication.

(b) Description of the Related Art

Device-to-device (D2D) communication is a method of having two devices directly communicate without relay of a base station.

When the D2D system uses orthogonal frequency division multiple access (OFDMA), power control is not performed among devices, and therefore when the D2D system uses an analog digital converter (ADC) having a small number of bits, a near-far problem occurs. Further, a far signal is embedded in a near signal and thus may not be received.

In particular, when the device broadcasts a discovery signal to discover an opposite device, the device transmits the discovery signal to a small number of subcarriers with maximum power to increase a discovery distance.

In this case, strengths of received signals have a large difference depending on the distance. For example, a path loss is a biquadrate of the distance, and in the case of the same transmission power, received signal power strength has a difference of 10⁴ times when the distance difference is 10 times and has a difference of 10⁸ times when the distance difference is 100 times. As described above, when the received signal power strengths have a large difference from each other, the number of ADC bits needs to be very large to effectively receive the received signals. However, when the number of ADC bits is large, costs may be increased. To maintain a small number of ADC bits, the received signal power strengths need to be input at a similar magnitude to each other.

Meanwhile, since the D2D system is operated by half duplexing, in order to consider simultaneous transmission, devices mapped to the same orthogonal frequency division multiplexing (OFDM) symbol is changed by a pseudo-random method or a Latin square method.

Therefore, a specific device may not transmit the discovery signals to adjacent devices in the same OFDM symbol. However, when the pseudo-random method or the Latin square method is applied, positions of the devices mapped to one OFDM symbol are randomly distributed, such that the strengths of received signals may have a large difference and the near-far problem may be severe.

To radically resolve the near-far problem, the device may transmit the discovery signal using a full band rather than using the OFDMA. However, when the full band is used, the devices need to transmit the discovery signals for a short period of time, and as a result, a transmission distance may be shortened.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for transmitting a discovery signal in device-to-device communication having advantages of reducing a near-far problem in the device-to-device communication.

An exemplary embodiment of the present invention provides a method for transmitting a discovery signal in device-to-device communication. The method includes: dividing a plurality of devices into groups including at least one device; transmitting, by each device belonging to a first group among the groups, a first discovery signal by an orthogonal frequency division multiple access (OFDMA) method; and transmitting, by each device belonging to the first group, a second discovery signal using all the usable subcarriers at different times.

The method may further include receiving, by at least one group other than the first group among the groups, the first discovery signal.

The method may further include receiving, by each device belonging to the first group, the second discovery signal.

The at least one group may acquire information on the devices belonging to the first group using the first discovery signal.

Each device belonging to the first group may acquire information on other devices different therefrom among the devices belonging to the first group using the second discovery signal.

The method may further include: after the transmitting of the first discovery signal, transmitting, by each device belonging to a second group among the groups, a third discovery signal by the OFDMA method; and after the transmitting of the second discovery signal, transmitting, by each device belonging to the second group, a fourth discovery signal using all the subcarriers at different times.

Another embodiment of the present invention provides a method for transmitting a discovery signal in device-to-device communication. The method includes: dividing a plurality of devices into groups including at least one device; transmitting, by each device belonging to a first group among the groups, a first discovery signal by an orthogonal frequency division multiple access (OFDMA) method; and transmitting, by at least one first device receiving the first discovery signal, a second discovery signal including information on devices belonging to the first group using all the usable subcarriers.

The first device may be a device belonging to groups other than the first group.

The method may further include receiving, by each device belonging to the first group, the second discovery signal.

Each device belonging to the first group may acquire information on other devices different therefrom among the devices belonging to the first group using the second discovery signal.

The method may further include: after the transmitting of the first discovery signal, transmitting, by each device belonging to a second group among the groups, a third discovery signal by the OFDMA method; and after the transmitting of the second discovery signal, transmitting, by at least one second device receiving the third discovery signal, a fourth discovery signal including information on devices belonging to the second group using all the subcarriers.

Yet another embodiment of the present invention provides a method for transmitting/receiving a discovery signal by a first device belonging to a first group. The method includes: transmitting a first discovery signal using a first subcarrier selected by an orthogonal frequency division multiple access (OFDMA) method; and receiving a second discovery signal including information on devices belonging to the first group from a second device different from the first device.

The second discovery signal may be received through all the usable subcarriers.

The second device may belong to the first group and be a device other than the first device.

The second device may be a device belonging to groups different from the first group.

The method may further include transmitting the first discovery signal using all the usable subcarriers.

The method may further include: receiving a second discovery signal including information on devices belonging to a second group from the second group different from the first group; and

transmitting the information included in the second discovery signal using all the usable subcarriers.

According to an embodiment of the present invention, it is possible to reduce the near-far problem by using the OFDMA method for long range transmission and using the full band for short range transmission after devices are divided into groups.

### BRIEF DESCRIPTION OF THE DRAWINGS

FIG. 1 is a diagram illustrating a concept of grouping adjacent devices among a plurality of devices.

FIG. 2 is a diagram illustrating an experimental result in which the plurality of devices are mapped as a plurality of groups by a wrap-around.

FIG. 3 is a diagram illustrating a case in which devices belonging to another group transmit discovery signals.

FIG. 4 is a diagram illustrating a case in which devices belonging to the same group transmit discovery signals.

FIG. 5 is a diagram illustrating a transmitting/receiving distance (Distance) to a minimum transmitting/receiving distance (Minimum distance) between devices allocated to one OFDM symbol.

FIG. 6 is a diagram illustrating a method for transmitting a discovery signal according to an exemplary embodiment of the present invention.

FIG. 7 is a diagram illustrating a method for transmitting a discovery signal according to another exemplary embodiment of the present invention.

FIG. 8 is a diagram illustrating an example of the method for transmitting a discovery signal of FIG. 7.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a device may be called a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like, and may include functions of all or some of the terminal, the MT, the MS, the AMS, the HR-MS, the SS, the PSS, the AT, the UE, and the like.

Further, a base station (BS) may be called an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like, and may also include functions of all or some of the ABS, the HR-BS, the nodeB, the eNodeB, the AP, the RAS, the BTS, the MMR-BS, the RS, the HR-RS, and the like.

A method for transmitting a discovery signal according to an exemplary embodiment of the present invention first divides a plurality of devices into several groups, and groups adjacent devices to belong to the same group. In phase 1, for devices present in a long range, a discovery signal is transmitted by dividing a band like in OFDMA, and in phase 2, for devices present in a short range, the discovery signal is transmitted by using a full band.

Hereinafter, the method for transmitting a discovery signal according to the exemplary embodiment of the present invention will be described in detail with reference to the accompanying drawings.

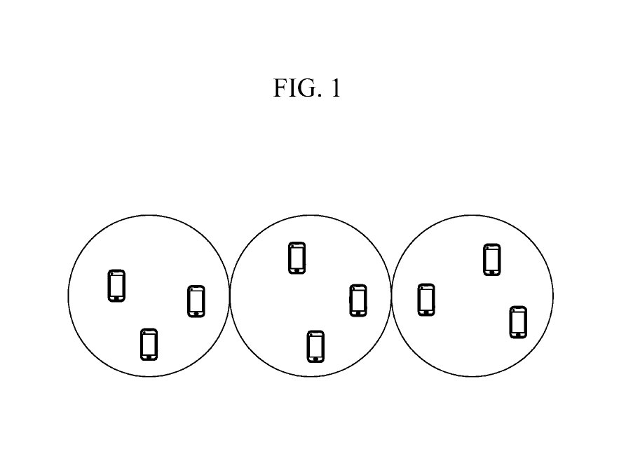

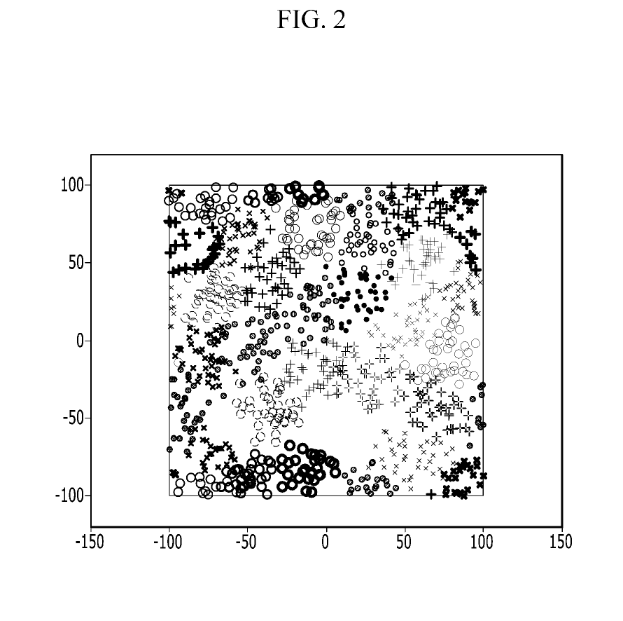

First, a method for mapping a plurality of devices as a group will be described with reference to FIGS. 1 and 2.

FIG. 1 is a diagram illustrating a concept of grouping adjacent devices among a plurality of devices.

As illustrated in FIG. 1, adjacent devices among the respective devices are grouped. Each device detects signals of other devices, and a group to which most devices having strength of the detected signal over a threshold value belong is selected. In this case, each device considers available resources and is thus uniformly distributed in each group. Here, the threshold value may be used in plural, and the plurality of threshold values may be allocated with different weights.

FIG. 2 is a diagram illustrating an experimental result in which the plurality of devices are mapped as a plurality of groups by a wrap-around. In FIG. 2, it is assumed that the number of devices is 1120 and the number of groups is 28.

Each device adds signals of the devices over a threshold value of 1 to signals of subcarriers of each group and signals of the devices over a threshold value of 2 thereto, and is allocated to a group in which a value obtained by multiplying the number of additionally usable subcarriers by the added value is largest. When the above method is used, the devices belonging to each group may be adjacently disposed to each other. Meanwhile, the devices belonging to each group may be grouped by being adjacently disposed to each other without controlling of a center.

As a method for grouping adjacent devices to each other, the method for using a threshold value as described above as well as other methods may be used. The method for grouping adjacent devices is known by a person having ordinary skill in the art to which the present invention pertains, and therefore the detailed description thereof will be omitted.

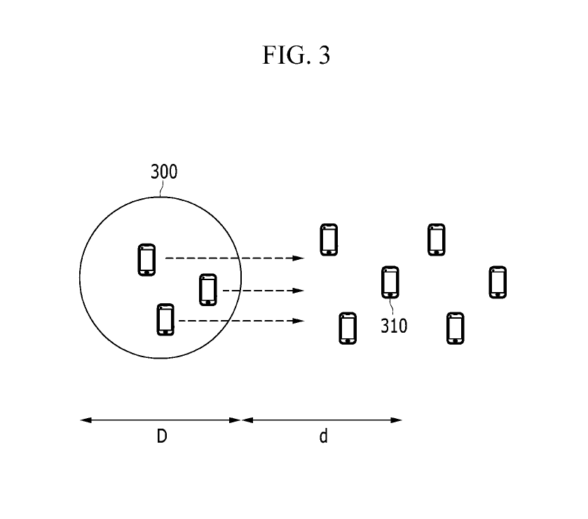

FIG. 3 is a diagram illustrating a case in which devices belonging to another group transmit discovery signals.

When devices belonging to a group 300 configure a signal based on an OFDMA method, each subcarrier signal transmitted from the group 300 is almost uniformly input to devices which are far away from the group 300. By doing so, the near-far problem may be resolved.

Referring to FIG. 3, it is assumed that the devices belonging to the group 300 are away from each other by D as maximum value, and a device 310 away from the group 300 by d receives a discovery signal. In the device 310 receiving the discovery signal from the group 300, a the closest distance (Min distance) from the group 300 and a the farthest distance (Max distance) from the group 300 are based on the following Equation 1.

$$\frac{Max Distance}{Min Distance} = \frac{d + D}{d} \qquad ( Equation 1 )$$

In the above Equation 1, when d is larger than D, a magnitude in the signal within the OFDM symbol does not show a large difference. In particular, d is increased for long range transmission and thus a magnitude of a received signal does not appear (i.e., power control is performed well), such that reception may be performed well.

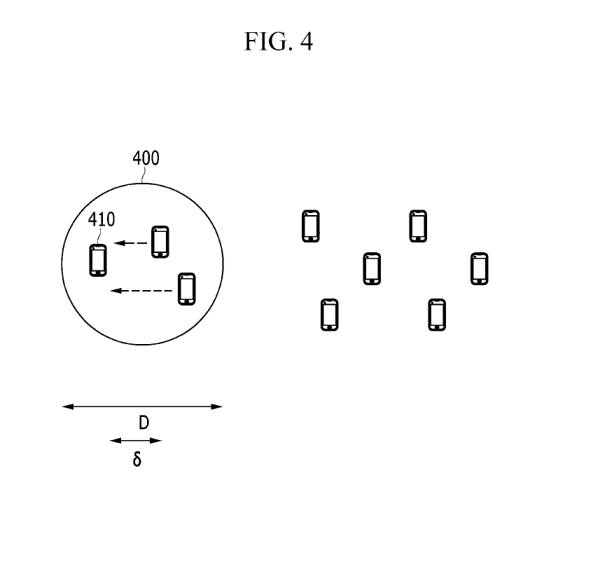

Meanwhile, when devices belonging to the same group transmit discovery signals to each other, the devices approach each other and therefore the near-far problem may be severe. FIG. 4 is a diagram illustrating a case in which devices belonging to the same group transmit discovery signals.

Referring to FIG. 4, it is assumed that devices belonging to a group 400 are separated from each other by a maximum of D, and the closest distance among the devices belonging to the group 400 is 8. In a device 410 receiving a discovery signal, a distance (min distance) from the closest device and a distance (max distance) from the farthest device are based on the following Equation 2.

$$\frac{Max Distance}{Min Distance} = \frac{D}{δ} \qquad ( Equation 2 )$$

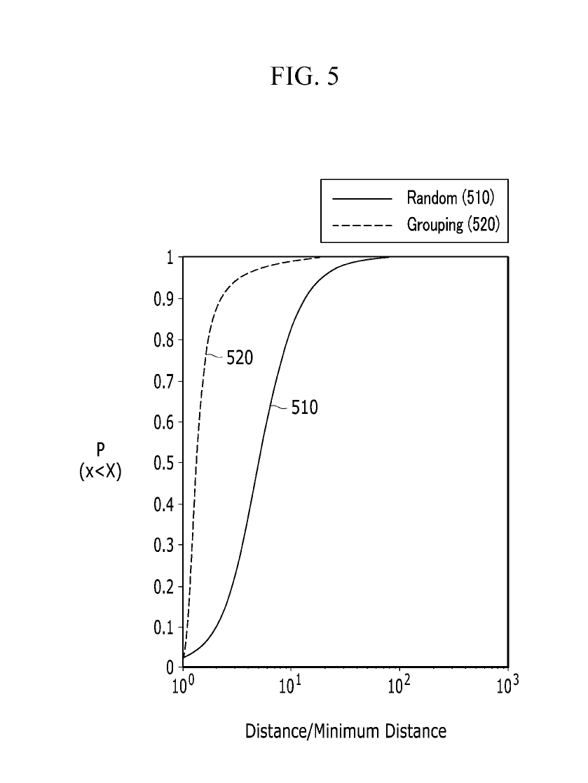

FIG. 5 is a diagram illustrating a transmitting/receiving distance (Distance) to a minimum transmitting/receiving distance (Minimum distance) between devices allocated to one OFDM symbol.

FIG. 5 is a graph illustrating a cumulative distribution function (CDF), in which an x axis represents transmitting/receiving distance/minimum transmitting/receiving distance, and a y axis represents the probability. Further, in FIG. 5, reference numeral 510 represents a case in which the OFDM symbols are mapped by a random method like the exiting method, and reference numeral 520 represents a case in which the devices are grouped and the OFDM symbols are mapped to each group, as illustrated in FIG. 2.

As illustrated in FIG. 5, when the devices are grouped as illustrated in FIG. 2, a distance from other devices compared with a device closest thereto is not large, except for some cases. However, when the OFDM symbols are configured by the existing random method, the distance from other devices compared with a device closest thereto is large. That is, when the OFDM symbols are configured by the existing random method, the near-far problem frequently occurs, but when the devices are grouped as illustrated in FIG. 2, the near-far problem occurs only in some environments. According to the exemplary embodiment of the present invention, the near-far problem which occurs only in some environments is solved by other methods.

Referring to FIG. 5, the reason why a portion in which a power control is not done is present is that the devices belonging to the same group or adjacent groups receive the discovery signal. That is, in the case of broadcasting for discovery, long range transmission almost does not have the near-far problem, but short range transmission has a severe near-far problem. Therefore, according to the exemplary embodiment of the present invention, to transmit the discovery signals in a short range, the OFDMA is not used and all the subcarriers are used. That is, when the device transmits the discovery signal, in the phase 1, a small number of subcarriers are used by the OFDMA method to transmit the discovery signal, and in the phase 2, all the subcarriers are used to transmit the discovery signals. The phase 1 is for long range devices and the phase 2 is for short range devices having the near-far problem.

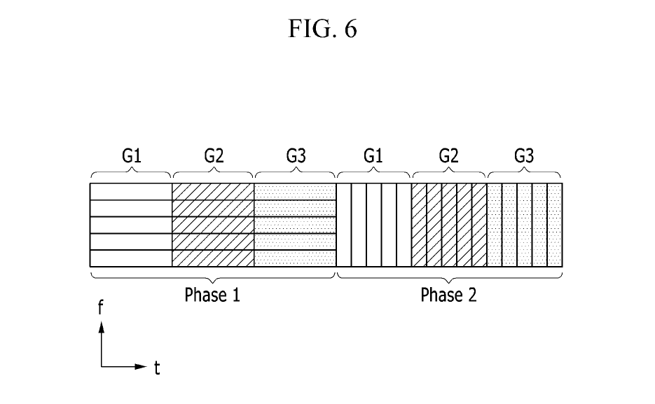

FIG. 6 is a diagram illustrating a method for transmitting a discovery signal according to an exemplary embodiment of the present invention. FIG. 6 illustrates the case in which a plurality of devices are divided into three groups G1, G2, and G3, and each group has five devices. A horizontal axis is a time base and represents an OFDM symbol, and a vertical axis is a frequency base and represents a subcarrier.

In the phase 1, the five devices belonging to one group simultaneously transmit the discovery signals for the long range transmission, and in the phase 2, the five devices belonging to one group alternately transmit the discovery signals to solve the near-far problem. In other words, in the phase 1, the five devices belonging to one group transmit the discovery signals by using one OFDM symbol for the long range transmission, and in the phase 2, the five devices belonging to one group alternately transmit the discovery signals by using all the subcarriers to solve the near-far problem.

Describing in more detail, five devices belonging to a group G1 transmit the discovery signals by using one OFDM symbol in the phase 1. Here, the five devices belonging to the group G1 are differentiated from each other by using different subcarriers in the phase 1. Further, each device belonging to the group G1 transmits the discovery signals by using all the subcarriers at different times in the phase 2. That is, in the phase 1, the devices belonging to the group G1 each transmit the discovery signals by the OFDMA method, and in the phase 2, the devices belonging to the group G1 transmit the discovery signals including their own information by a time division multiple access (TDMA) method.

A method for transmitting a discovery signal by groups G2 and G3 in phase 1 and phase 2 is the same as the method for transmitting a discovery signal by the group G1.

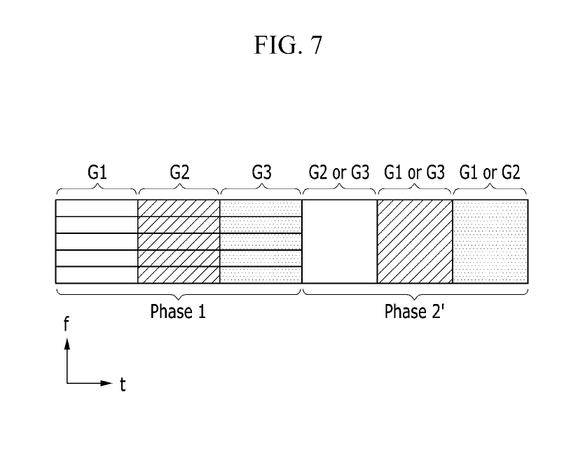

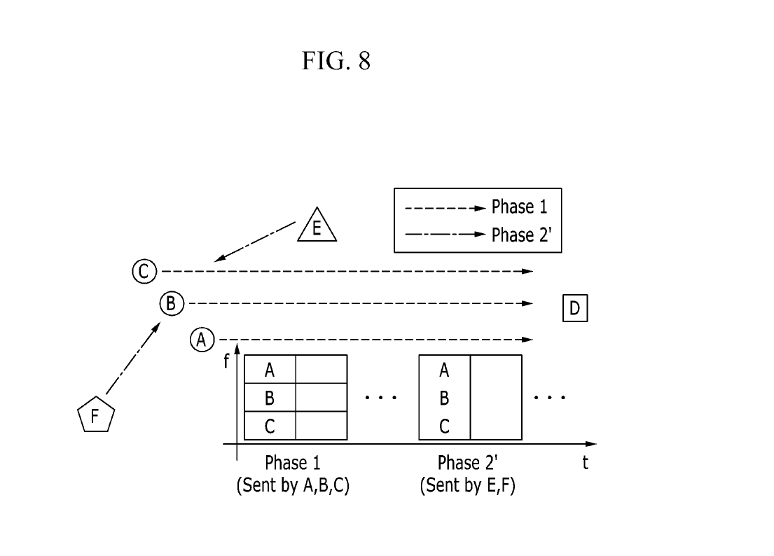

Meanwhile, in the phase 2 of FIG. 6, each device need not necessarily transmit the discovery signals including its own information. That is, in phase 2, at least one device may transmit the entire device information in the group by using all the subcarriers in an OFDMA data format. The exemplary embodiment of the present invention will now be described in more detail with reference to FIGS. 7 and 8.

FIG. 7 is a diagram illustrating a method for transmitting a discovery signal according to another exemplary embodiment of the present invention. FIG. 7 illustrates the case in which a plurality of devices are divided into three groups G1, G2, and G3 and each group has five devices. Further, a horizontal axis is a time base and represents an OFDM symbol, and a vertical axis is a frequency base and represents a subcarrier.

Phase 1 of FIG. 7 is the same as the phase 1 of FIG. 6. That is, in the phase 1, five devices belonging to one group transmit the discovery signals by the OFDMA method for the long range transmission.

In the phase 1, when each group transmits the discovery signals including its own information, the devices belonging to other groups receive the information on the group transmitting the discovery signal

For example, in the phase 1, when a group G1 transmits the discovery signal including its own information, devices belonging to other groups G2 and G3 receive the discovery signal of the group G1 to acquire the information on the group G1.

The devices belonging to the groups G2 and G3 receive the information corresponding to the group G1 in the phase 1, and therefore at least one of the devices belonging to the groups G2 and G3 transmits the discovery signal including all the information on the group G1 in phase 2′. The devices belonging to the groups G1 and G3 receive the information corresponding to the group G2 in the phase 1, and therefore at least one of the devices belonging to the groups G1 and G3 transmits the discovery signal including all the information on the group G2 in the phase 2′. Further, the devices belonging to the groups G1 and G2 receive the information corresponding to the group G3 in the phase 1 and therefore at least one of the devices belonging to the groups G1 and G2 transmits the discovery signal including all the information on the group G3 in phase 2′.

Here, in the phase 2′, the discovery signals are transmitted by using all the subcarriers in the OFDMA data format. Since the discovery signals are transmitted by using all the subcarrier signals, a transmission distance thereof is shorter than in the phase 1, such that the discovery signals may be received by the devices in the short range. In the phase 2′, the device transmitting the discovery signal may be periodically defined sequentially with determinism. For example, only the devices (devices belonging to G2 or G3) completely receiving the information on the group G1 in the phase 1 transmit the information thereof, and otherwise do not transmit the information. Meanwhile, in the phase 2′, the device transmitting the discovery signal may be in plural. In phase 2′, when the plurality of devices use all the subcarriers to transmit the discovery signals, a problem of coverage reduction may be reduced.

Meanwhile, when the discovery signal is transmitted by the method illustrated in FIG. 7, the half duplexing problem may also be solved. That is, the devices belonging to the group G1 transmit the discovery signal in the phase 1 and receive the discovery signal in the phase 2′, and therefore even the half duplexing transmission problem is naturally solved.

Further, when the discovery signal is transmitted by the method illustrated in FIG. 7, the near-far problem may also be solved. The devices belonging to the group G1 transmit the discovery signals by the OFDMA method in the phase 1, and therefore the devices belonging to another group G2 or G3 which are separated from each other have a high probability of receiving the information on the group G1. Further, the group G2 or G3 retransmits the received information in the phase 2′, such that the devices belonging to the group G1 may acquire the information on the group G1 through another group G2 or G3. Meanwhile, when the number of devices simultaneously transmitting the discovery signal in the phase 2′ is smaller than the number of devices simultaneously transmitting the discovery signal in the phase 1, power consumption due to the transmission may be reduced. The number of devices simultaneously transmitting the discovery signal in phase 2′ is determined by a tradeoff between coverage (or receiving success rate) and power consumption.

FIG. 8 is a diagram illustrating an example of the method for transmitting a discovery signal of FIG. 7. In FIGS. 8, A, B, C, D, E, and F represent devices, in which the devices A, B, and C belong to the group G1 which is the same group and are adjacent to each other.

In phase 1, the devices A, B, and C each transmit the discovery signals by the OFDMA method for dividing and transmitting subcarriers within a transmission time of the group G1. The discovery signal includes the information on the devices A, B, and C, respectively. The devices A, B, and C each use the small number of subcarriers for several OFDM symbol to be able to increase the transmission distance, and the remote device D may also receive the information on the devices A, B, and C. In view of the devices D, E, and F belonging to the group G1 and other groups, the signal power strengths received from the devices A, B, and C are similar to one another, and therefore performance degradation due to the analog digital converter (ADC) does not occur. In particular, the D remote from the group G1 almost does not have the near-far problem since the distances from the devices A, B, and C are similar to one another. Meanwhile, the device A may not receive the signals of the devices B and C due to the half duplexing method. When the device A is not based on the half duplexing method, the signals of the devices B and C have a large difference in signal strength, and therefore quantization noise may occur in the ADC and the device A may not receive the signals of the devices B and C.

In the phase 2′, at least one of the devices which do not belong to the group G1 transmits the information on the group G1 through the discovery signal. In this case, the transmitted discovery signals are transmitted by using all the subcarriers, and therefore the transmission distance is shorter than in the phase 1. That is, the devices E and F receive the discovery signal of the group G1 in the phase 1, and therefore again transmit the received information to the surroundings in the phase 2′. The device A does not receive the signals of the devices belonging to its own group G1 in the phase 1 due to the half duplexing problem or the near-far problem. However, the device A may receive the information on the devices belonging to the group G1 with the help of the devices E or F belonging to other groups in the phase 2′.

According to the exemplary embodiment of the present invention, in the phase 1, the remote devices may receive the discovery signals, and in the phase 2, the discovery signals of the devices belonging to the same group or the discovery signals of the device which are not received due to the near-far problem may be received.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a discovery signal in device-to-device communication, comprising:
dividing a plurality of devices into groups including at least one device;
transmitting, by each device belonging to a first group among the groups, a first discovery signal by an orthogonal frequency division multiple access (OFDMA) method; and
transmitting, by each device belonging to the first group, a second discovery signal using all the usable subcarriers at different times.

2. The method of claim 1, further comprising receiving, by at least one group other than the first group among the groups, the first discovery signal.

3. The method of claim 1, further comprising receiving, by each device belonging to the first group, the second discovery signal.

4. The method of claim 2, wherein the at least one group acquires information on the devices belonging to the first group using the first discovery signal.

5. The method of claim 3, wherein each device belonging to the first group acquires information on other devices different therefrom among the devices belonging to the first group using the second discovery signal.

6. The method of claim 1, further comprising:
after the transmitting of the first discovery signal, transmitting, by each device belonging to a second group among the groups, a third discovery signal by the OFDMA method; and
after the transmitting of the second discovery signal, transmitting, by each device belonging to the second group, a fourth discovery signal using all the subcarriers at different times.

7. A method for transmitting a discovery signal in device-to-device communication, comprising:
dividing a plurality of devices into groups including at least one device;
transmitting, by each device belonging to a first group among the groups, a first discovery signal by an orthogonal frequency division multiple access (OFDMA) method; and
transmitting, by at least one first device receiving the first discovery signal, a second discovery signal including information on the devices belonging to the first group using all the usable subcarriers.

8. The method of claim 7, wherein the first device is a device belonging to groups other than the first group.

9. The method of claim 7, further comprising receiving, by each device belonging to the first group, the second discovery signal.

10. The method of claim 9, wherein each device belonging to the first group acquires information on other devices different therefrom among the devices belonging to the first group using the second discovery signal.

11. The method of claim 7, further comprising receiving, by at least one group other than the first group among the groups, the first discovery signal,
wherein the first device belongs to the at least one group.

12. The method of claim 7, further comprising:
after the transmitting of the first discovery signal, transmitting, by each device belonging to a second group among the groups, a third discovery signal by the OFDMA method; and
after the transmitting of the second discovery signal, transmitting, by at least one second device receiving the third discovery signal, a fourth discovery signal including information on devices belonging to the second group using all the subcarriers.

13. A method for transmitting/receiving, by a first device belonging to a first group, a discovery signal, comprising:
transmitting a first discovery signal using a first subcarrier selected by an orthogonal frequency division multiple access (OFDMA) method; and
receiving a second discovery signal including information on devices belonging to the first group from a second device different from the first device.

14. The method of claim 13, wherein the second discovery signal is received through all the usable subcarriers.

15. The method of claim 13, wherein the second device belongs to the first group and is a device other than the first device.

16. The method of claim 13, wherein the second device is a device belonging to groups different from the first group.

17. The method of claim 13, further comprising transmitting the first discovery signal using all the usable subcarriers.

18. The method of claim 13, further comprising:
receiving a second discovery signal including information on devices belonging to a second group from the second group different from the first group; and
transmitting the information included in the second discovery signal using all the usable subcarriers.
